(19) United States
(12) Patent Application Publication
(10) Pub. No.: US 2025/0380687 A1
(43) Pub. Date: Dec. 18, 2025

(54) Herbicide Delivery System and Method of Use

(71) Applicant: Jason Malouf Abraham, Canadian, TX (US)

(72) Inventor: Jason Malouf Abraham, Canadian, TX (US)

(21) Appl. No.: 18/893,814

(22) PCT Filed: Mar. 23, 2023
(86) PCT No.: PCT/US2023/064893

§ 371 Date: Sep. 23, 2024

Related U.S. Application Data
(60) Provisional application No. 63/269,816, filed on Mar. 23, 2022.
(60) Provisional application No. 63/364,440, filed on May 10, 2022.
(60) Provisional application No. 63/378,362, filed on Oct. 4, 2022.
(60) Provisional application No. 63/381,772, filed on Nov. 1, 2022.

(51) Int. Cl. A01N 25/08; F41B 11/80; G06V 20/10; G06V 20/17

(52) U.S. Cl. CPC A01N 25/08; F41B 11/80; G06V 20/17; G06V 20/188

(57) ABSTRACT

An herbicide pellet system for efficient and accurate delivery of herbicides to plurality of unwanted plants is disclosed. Comprising the herbicide pellet system comprising an herbicide pellet and a delivery system for distributing the herbicide pellet to a portion of the plurality of unwanted plants. The herbicide pellet comprises a non-liquid degradable herbicide configured to release an herbicide near unwanted plant after a period or a rain event. The delivery system is configured to project the herbicide pellet as a projectile toward the unwanted plant among the plurality of unwanted plants. The herbicide pellet is of sufficient weight and shape to travel through the air in a predictable trajectory when projected by the delivery system. The herbicide pellet is configured to carry an herbicide dosage of an herbicide. The herbicide dosage is calculated to correlate with a plant height of the unwanted plant.

### CROSS-REFERENCE TO RELATED APPLICATIONS

This application is co-pending with, claims benefit to, and incorporates by reference PCT/US23/64893 filed Mar. 23, 2023. Wherein, '893 claims and was co-pending with these US patent applications: 63/269,816 filed Mar. 23, 2022, 63/364,440 filed May 10, 2022, 63/378,362 filed Oct. 4, 2022, and 63/381,772 filed Nov. 1, 2022.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Effective and efficient delivery of herbicides to unwanted vegetation, such as invasive brush and trees, is a significant challenge in agricultural and land management practices. Traditional methods often require a worker to physically approach each unwanted plant individually. This process is not only time-consuming-often limiting a worker to covering just 2-4 acres per day-but also exposes the worker to hazardous conditions like difficult terrain and dangerous wildlife, including rattlesnakes.

Existing herbicide delivery systems include the use of liquid sprays and dissolvable pellets. Liquid sprays can be inefficient due to drift and imprecise application, potentially affecting non-target vegetation and leading to environmental concerns. Dissolvable pellets, while an improvement, often lack the necessary weight and structural integrity to be delivered accurately over long distances or to penetrate dense foliage.

Prior art references such as US20090247408A1 (Koschnick) disclose systems for delivering control agents using projectiles. These systems typically involve two-part projectiles with separable designs and gas-propelled launching devices. However, they may not provide the necessary accuracy or effectiveness in herbicide delivery, particularly in arid environments where water scarcity limits the activation of certain herbicide formulations.

Other methods, including the use of paintball guns to deliver liquid-filled capsules, suffer from issues related to the fragility of the capsules and the potential for breakage during acceleration or flight. The liquid nature of paintball bullets can result in inconsistent delivery and premature release of contents, reducing the effectiveness of the herbicide application.

There is a need for an improved herbicide delivery system that allows for efficient, accurate, and environmentally friendly application of herbicides, particularly suitable for challenging terrains and arid conditions. Such a system should enable workers to deliver precise dosages of herbicide to unwanted plants from a distance, reducing labor requirements and minimizing exposure to hazardous conditions.

The present invention addresses these needs by providing a herbicide pellet system comprising semi-rigid, shell-less, water-soluble herbicide pellets. These pellets are designed to maintain integrity during acceleration and projection, allowing for predictable trajectories when delivered using various mechanisms such as pellet guns, drones, or other projection devices.

The herbicide pellets are formulated to release the herbicide upon contact with minimal moisture, ensuring effectiveness even in arid environments. Each pellet carries a specific dosage of herbicide calculated to correlate with the height of the unwanted plant. This allows a workman to visually assess the plant's height and apply the appropriate number of pellets, enhancing the precision and effectiveness of the treatment.

By overcoming the limitations of prior art, the present invention offers a novel and efficient solution for herbicide delivery. It enhances vegetation management practices by reducing environmental impact, lowering labor costs, and improving the accuracy and effectiveness of herbicide application, particularly in areas where traditional methods are less efficient.

### BRIEF SUMMARY OF THE INVENTION

Herbicide pellet system for efficient and accurate delivery of herbicides to plurality of unwanted plants is disclosed. Comprising said herbicide pellet system comprising an herbicide pellet and a delivery system for distributing said herbicide pellet to a portion of said plurality of unwanted plants. Said herbicide pellet comprises a non-liquid degradable herbicide configured to release an herbicide near unwanted plant after a period or a rain event. Said delivery system is configured to project said herbicide pellet as a projectile toward said unwanted plant among said plurality of unwanted plants. Said herbicide pellet is of sufficient weight and shape to travel through the air in a predictable trajectory when projected by said delivery system. Said herbicide pellet is configured to carry an herbicide dosage of an herbicide. Said herbicide dosage is calculated to correlate with a plant height of said unwanted plant. Accordingly, said herbicide pellet system is configured for: allowing a workman to visually judge said plant height of said unwanted plant, calculating an appropriate dosage of herbicide according to said plant height of said unwanted plant by dividing an apparent height of said plant height by a dosage per height, and applying a multiple of said herbicide pellet to said unwanted plant. Said delivery system of said herbicide pellet system comprises herbicide pellet gun. Said herbicide pellet gun is configured for shooting said herbicide pellet at a portion of said plurality of unwanted plants. Said herbicide pellet gun comprises hopper, barrel and a body. Said hopper is configured to hold a plurality of said herbicide pellet. Said herbicide pellet system comprises a method of use is disclosed. Comprising loading at least one of said herbicide pellet in said hopper of said herbicide pellet gun, transferring said herbicide pellet into ammunition inlet of said herbicide pellet gun, aiming said barrel at said unwanted plant, shooting said herbicide pellet at said unwanted plant, and allowing said herbicide pellet to release an herbicide configured to kill said unwanted plant. Said herbicide pellet comprise a weight between 0.8 and 2 grams. Said herbicide pellet are configured to travel through the air when fired by said herbicide pellet gun in a predictable trajectory.

Said herbicide pellet system for efficient and accurate delivery of herbicides to said plurality of unwanted plants is disclosed. Comprising said herbicide pellet system comprising said herbicide pellet and a delivery system for distributing said herbicide pellet to a portion of said plurality of unwanted plants. Said herbicide pellet comprises a non-liquid degradable herbicide configured to release an herbicide near said unwanted plant after a period or a rain event. Said delivery system is configured to project said herbicide pellet as a projectile toward said unwanted plant among said plurality of unwanted plants. Said herbicide pellet is of sufficient weight and shape to travel through the air in a predictable trajectory when projected by said delivery system.

Said herbicide pellet system for efficient and accurate delivery of herbicides to said plurality of unwanted plants is disclosed. Comprising said herbicide pellet system comprising said herbicide pellet and a delivery system for distributing said herbicide pellet to a portion of said plurality of unwanted plants. Said herbicide pellet comprises a non-liquid degradable herbicide configured to release an herbicide near said unwanted plant after a period or a rain event. Said delivery system is configured to project said herbicide pellet as a projectile toward said unwanted plant among said plurality of unwanted plants. Said herbicide pellet is of sufficient weight and shape to travel through the air in a predictable trajectory when projected by said delivery system. Said herbicide pellet is configured to carry an herbicide dosage of an herbicide. Said herbicide dosage is calculated to correlate with said plant height of said unwanted plant. Accordingly, said herbicide pellet system is configured for: allowing a workman to visually judge said plant height of said unwanted plant, calculating an appropriate dosage of herbicide according to said plant height of said unwanted plant by dividing an apparent height of said plant height by a dosage per height, and applying a multiple of said herbicide pellet to said unwanted plant. Said herbicide pellet comprise a weight substantially equal to 1.25 grams. Said herbicide pellet are configured to travel through the air when fired by said herbicide pellet gun in a predictable trajectory.

### BRIEF DESCRIPTION OF THE SEVERAL VIEWS OF THE DRAWING

FIGS. 1A, 1B, and 1C illustrate two perspective overviews of an herbicide pellet 106 and an elevated side view of said herbicide pellet 106 in three variations 140.

FIG. 1D illustrates an elevated side view of an herbicide pellet gun 100.

FIGS. 1E and 1F illustrate an elevated side view and perspective overview of said loose channel 142.

FIG. 2A illustrates a perspective overview of a drone delivery system 200 for said herbicide pellet 106.

FIG. 2B illustrates a block diagram 240 of said drone delivery system 200.

FIG. 3A illustrates a perspective overview of said ranchland 300 with a flight plan 310.

FIG. 3B illustrates a perspective overview of said drone delivery system 200 treating said plurality of unwanted plants 302 at one or more target points 314.

FIG. 4 illustrates a drone bullet feeding assembly 400.

FIG. 5A illustrates a perspective overview of a livestock herbicide delivery system 500 on a livestock 502.

FIG. 5B illustrates a perspective overview of said livestock herbicide delivery system 500.

FIGS. 6A and 6B illustrate a perspective overview and elevated side view of said lower portion 512 without a said lid portion 518 attached.

FIG. 7 illustrates a block diagram 700 of said livestock herbicide delivery system 500.

FIG. 8A illustrates a detailed view of said ranchland 300 with a plurality of said livestock 502 under a portion of said plurality of unwanted plants 302 with a migration path 802 of a portion of said livestock 502.

FIG. 8B illustrates a perspective overview of said livestock 502 under said unwanted plant 302a.

FIGS. 9A and 9B illustrate a perspective overview and detailed view of a helicopter 906 with one or more herbicide dispenser assemblies 900.

FIG. 10A illustrates a 2D elevated side view of said first herbicide dispenser 912a.

FIG. 10B illustrates a simplified configuration 1002 of said first herbicide dispenser 912a.

FIG. 11A illustrates a block diagram 1106 of a flight herbicide dispenser assembly 1108 comprising said one or more herbicide dispenser assemblies 900.

FIG. 11B illustrates a perspective overview of said one or more herbicide dispenser assemblies 900 over said unwanted plant 302a.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

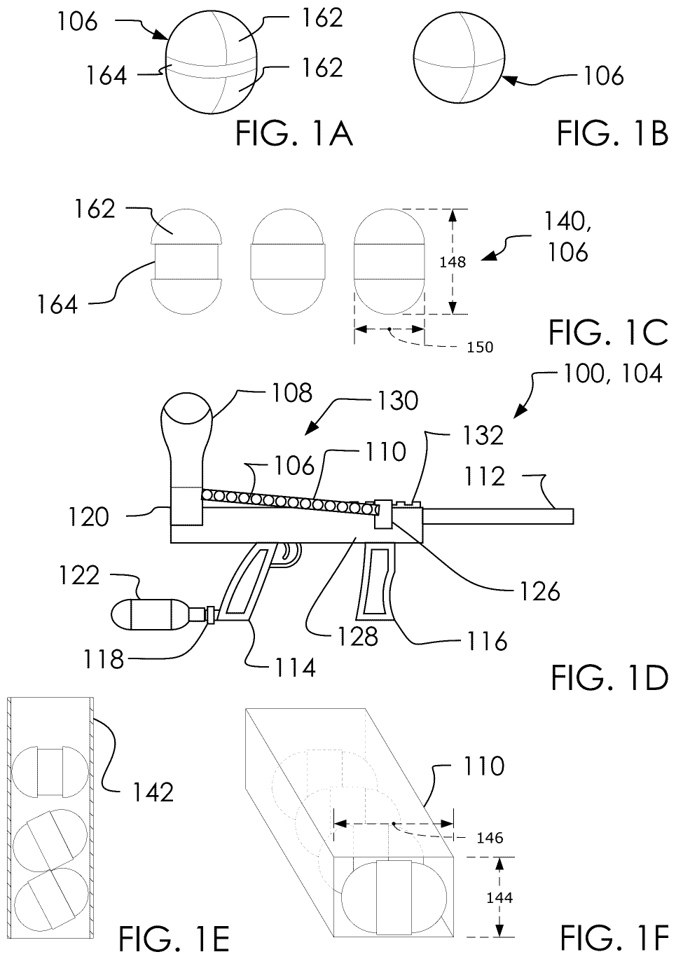

FIGS. 1A, 1B, and 1C illustrate two perspective overviews of an herbicide pellet 106 and an elevated side view of said herbicide pellet 106 in three variations 140.

In one embodiment, said herbicide pellet 106 can comprise a non-liquid degradable herbicide configured to release an herbicide near unwanted plant 302a after a period or a rain event. In one embodiment, said herbicide pellet 106 can comprise an herbicide known in the United States as a “2,4-D Herbicide” being formulated for the treatment of and destruction of unwanted plants such as mesquite trees.

In one embodiment, said herbicide pellet 106 can comprise a musket ball being hard and substantially unlikely to disintegrate in barrel 112 of herbicide pellet gun 100.

Existing herbicides for application on plurality of unwanted plants 302 are typically liquid based. By making said herbicide pellet 106 hard and non-liquid, in one embodiment, can allow for consistent handling and reliable aim from said herbicide pellet gun 100.

In one embodiment, said herbicide pellet 106 can comprise a substantially spherical shape being configured to fire out of said barrel 112 of said herbicide pellet gun 100, as is known in the art. In one embodiment, said herbicide pellet 106 can comprise a 50-caliber size. Wherein, a 50-caliber size is more reliable when handled by ammunition delivery assembly 130.

In one embodiment, said herbicide pellet 106 can be configured to carry a dosage of an herbicide. Wherein, said dosage can be configured to treat said unwanted plant 302a according to its a height. For example, where said unwanted plant 302a is a mesquite tree, said herbicide pellet 106 can be configured with sufficient herbicide to kill a 3-foot-high tree. Where said unwanted plant 302a is six feet tall, a workman can shoot two of said herbicide pellet 106 at that tree. Accordingly, herbicide pellet system 104 is configured to allow said workman to visually judge the height of said unwanted plant 302a and apply an appropriate dosage of herbicide on said unwanted plant 302a.

In one embodiment, said herbicide pellet system 104 can comprise a method of use which can comprise: loading at least one of said herbicide pellet 106 in hopper 108 of said herbicide pellet gun 100, transferring said herbicide pellet 106 into ammunition inlet 126 of said herbicide pellet gun 100, aiming said barrel 112 at said unwanted plant 302a, shooting said herbicide pellet 106 at said unwanted plant 302a, and allowing said herbicide pellet 106 to release an herbicide configured to kill said unwanted plant 302a.

In one embodiment, each among said herbicide pellet 106 can comprise two rounded ends 162 and a waistband 164.

Said two rounded ends 162 and said waistband 164 can comprise different dimensions, such as a different circumference as seen from the elevated side view of FIG. 1E. Accordingly, if said herbicide pellet 106 were to roll down a loose channel 142 rather than an ammunition feeder tube 110, then said herbicide pellet 106 would become misaligned and said two rounded ends 162 and said waistband 164 from adjacent bullets can become intertwined as illustrated in FIG. 1E.

Variations in said two rounded ends 162 and said waistband 164 can be the result of a manufacturing process used to press the raw materials of said herbicide pellet 106 which can press on said two rounded ends 162 at both ends to form said herbicide pellet 106.

FIG. 1D illustrates an elevated side view of said herbicide pellet gun 100.

In one embodiment, said herbicide pellet system 104 can comprise use of either said herbicide pellet gun 100 for shooting said herbicide pellet 106.

Paintball guns are well known as a recreational toy. The purpose of such a gun is to fire paint balls at other players in a simulated war game or capture the flag style game. This technology has been around for decades.

Quoting now from non-patent literature entitled “Paintball Prodigy”, “Paintballs . . . are spherical gelatin capsules containing biodegradable polyethylene glycol, other non-toxic and water-soluble dyes, and other substances. These capsules are designed in such a way to hold the fill and not break unless it makes a heavy impact with a surface.

A paintball's gelatin shell is designed to break on impact. The most popular paintball and paintball marker caliber is 0.68, which is considered to be the standard size for paintballs. 0.50 caliber is the second most popular, which is used in lower-impact games.”

Said herbicide pellet 106 can be a 50-caliber round, and can be fired out of a standard paintball gun without modification. However, one feature of said herbicide pellet system 104 can comprise improvements to said hopper 108 and said ammunition feeder tube 110. These improvements can ensure safe and reliable delivery of said herbicide pellet 106 from said hopper 108 to said barrel 112. Further, these improvements can slow the delivery of said herbicide pellet 106 to ensure fewer jams in said herbicide pellet gun 100.

As is known in the art, said herbicide pellet gun 100 or a standard paintball gun can comprise a first grip 114, a second grip 116 and a pressurized gas inlet 118, a feed neck 120, a compressed gas can 122, a compressed gas line 124 (illustrated below).

In one embodiment, said ammunition feeder tube 110 can connect between said feed neck 120 and said ammunition inlet 126 in a body 128 of said herbicide pellet gun 100. In one embodiment, said ammunition feeder tube 110 can connect to said feed neck 120 at a point being relatively above said ammunition inlet 126 when oriented with said first grip 114 toward the ground. Accordingly, said second grip 116 can travel within said ammunition feeder tube 110 as pulled by gravity from said feed neck 120 to said ammunition inlet 126. In one embodiment, said ammunition feeder tube 110 can comprise a hollow cylinder to allow said herbicide pellet 106 to roll freely within said ammunition feeder tube 110. Further, said ammunition feeder tube 110 can be transparent to allow a user to see the movement of said herbicide pellet 106 within said ammunition feeder tube 110.

One distinction between said herbicide pellet gun 100 and a standard paintball gun can comprise said ammunition delivery assembly 130 comprising said hopper 108 and said herbicide pellet 106, as described herein.

In one embodiment, said herbicide pellet gun 100 can comprise an electric accelerator instead of a compressed air discharge for shooting said herbicide pellet 106.

In one embodiment, said herbicide pellet gun 100 can comprise a modification of off the shell paint ball guns. For example, said herbicide pellet gun 100 can comprise a pistol configuration, a riffle configuration (as illustrated), a pump action, a semi-automatic configuration, or similar as is known in the art. In one embodiment, said compressed gas can 122 can comprise compressed gas or CO2 cans.

In one embodiment, said hopper 108 can be filled with a plurality of said herbicide pellet 106.

In one embodiment, said ammunition delivery assembly 130 can be offset from said barrel 112 to allow for aiming and sights down the length of said barrel 112.

In one embodiment, said herbicide pellet gun 100 can comprise one or more accessory brackets 132 for attaching accessories such as scopes, laser sights, and similar, as is known in the art.

In one embodiment, said ammunition delivery assembly 130 and said barrel 112 can be offset to allow a sights 502 of said herbicide pellet gun 100 to be visible beside said hopper 108.

As is known in the art, said herbicide pellet gun 100 can be made of metal for reliability and toughness or from plastics for lightness and disposability.

FIGS. 1E and 1F illustrate an elevated side view and perspective overview of said loose channel 142.

Accordingly, said ammunition feeder tube 110 can comprise a feeder tube height 144 and a feeder tube width 146 being configured to be substantially similar to a bullet height 148 and a bullet width 150; wherein, as said herbicide pellet 106 roll down the length of said ammunition feeder tube 110, they will naturally align within said ammunition feeder tube 110 and roll along said waistband 164 so as to avoid entanglement with adjacent bullets.

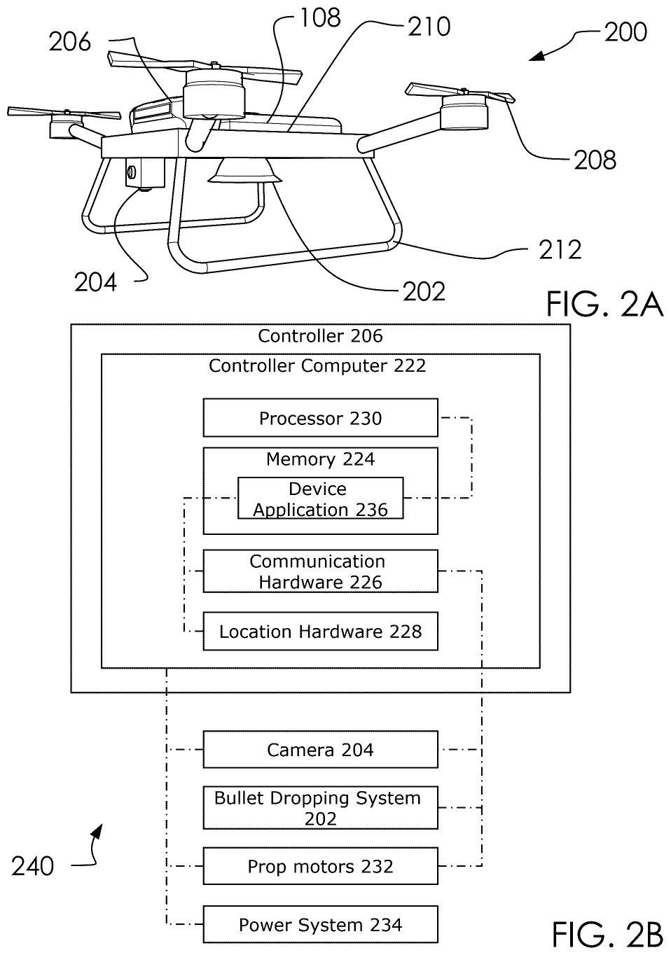

FIG. 2A illustrates a perspective overview of a drone delivery system 200 for said herbicide pellet 106.

In one embodiment, said herbicide pellet system 104 can comprise said drone delivery system 200 as described herein.

In one embodiment, said drone delivery system 200 can comprise an autonomous drone, a manually piloted drone, or similar, as is known in the art.

Said drone delivery system 200 can comprise said hopper 108, a bullet dropping system 202, a camera 204, a controller 206, a plurality of propellers 208 and a support frame 210.

Said support frame 210 can comprise a landing gear 212, as illustrated.

FIG. 2B illustrates a block diagram 240 of said drone delivery system 200.

In one embodiment, said controller 206 can comprise a controller computer 222 comprising at least a memory 224, a communication hardware 226, a location hardware 228 and a processor 230.

Further, said drone delivery system 200 can comprise said bullet dropping system 202, said camera 204, a plurality of prop motors 232 connected to said plurality of propellers 208, and a power system 234.

Said herbicide pellet system 104 can further comprise a device application 236 configured to be stored in said memory 224 and to execute in said processor 230. In one embodiment, said device application 236 can be configured to receive visual data from said camera 204, and location and positioning data from said location hardware 228. Said device application 236 can be configured to process this incoming data and to control a location of said drone delivery system 200 using said plurality of prop motors 232 as is known in the art. In one embodiment, said device application 236 can be programmed for: flying over ranchland 300, capturing images of said plurality of unwanted plants 302 according to a known location such as GPS, and processing and mapping the location of said plurality of unwanted plants 302. In one embodiment, said device application 236 can further be configured for: automatically identifying said plurality of unwanted plants 302, hovering over a portion of said plurality of unwanted plants 302, dropping said herbicide pellet 106 on a portion of said plurality of unwanted plants 302 using said bullet dropping system 202, and making a record of each among said plurality of unwanted plants 302 which have been treated with said herbicide pellet 106.

As is known in the art: said location hardware 228 can comprise GPS, gyroscopes, or similar; said power system 234 can comprise a battery or battery pack; said communication hardware 226 can comprise a wired bus, a wireless protocol, or a wireless networking standard; said controller computer 222 can comprise a system-on-a-chip or a plurality of components. In one embodiment, navigation hardware can be separate from and commanded by said device application 236.

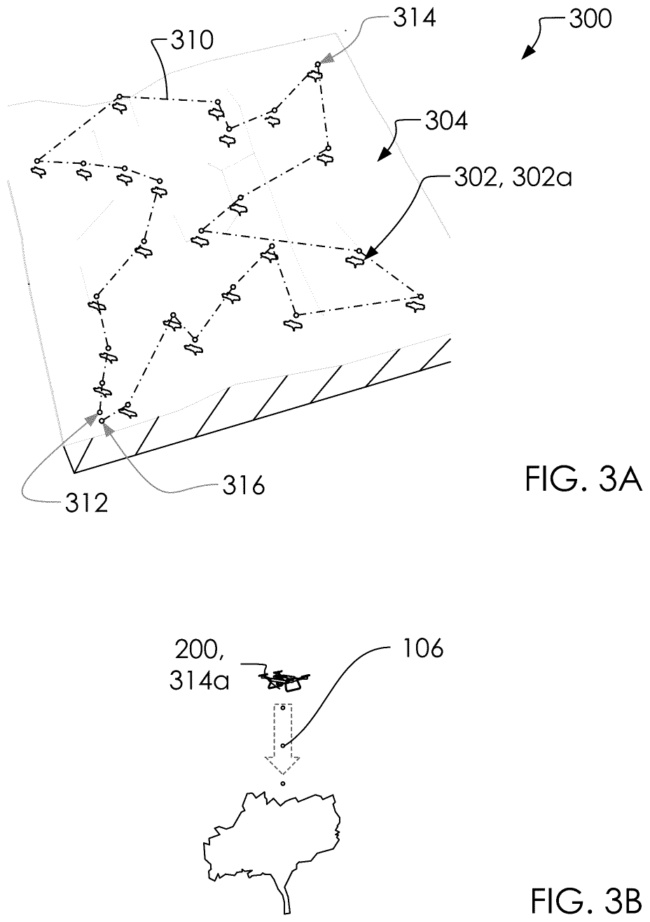

FIG. 3A illustrates a perspective overview of said ranchland 300 with a flight plan 310.

FIG. 3B illustrates a perspective overview of said drone delivery system 200 treating said plurality of unwanted plants 302 at one or more target points 314.

Said ranchland 300 can comprise said plurality of unwanted plants 302 and an uneven terrain 304.

One purpose of said herbicide pellet system 104 is to provide a more efficient and accurate delivery of herbicides for said plurality of unwanted plants 302, such as mesquite trees. For this discussion said unwanted plant 302a can comprise the singular of said plurality of unwanted plants 302.

In one embodiment, said herbicide pellet system 104 can further comprise said flight plan 310 being loaded into said device application 236. In one embodiment, said flight plan 310 can comprise a collection of 3D points across and above said ranchland 300 being configured to be clear of obstacles and above a portion of said plurality of unwanted plants 302. Wherein said flight plan 310 can be used to fly said drone delivery system 200 from a starting point 312, to said one or more target points 314 above a portion of said plurality of unwanted plants 302, release said herbicide pellet 106 over said unwanted plant 302a, document treatment, and return to end point 316 (a landing point).

Similarly, a workman can walk through said ranchland 300 and distribute said herbicide pellet 106. It follows that said herbicide pellet system 104 would be suitable for treatment of said plurality of unwanted plants 302 from a vehicle such as a truck, side-by-side, ATV, UTV, motorcycle, or similar. Wherein, said herbicide pellet gun 100 can attach to said compressed gas line 124 when traveling in said vehicle since an air compressor or larger tank of compressed air can be kept in said vehicle without a burden on said workman.

In one embodiment, said herbicide pellet gun 100 can be configured to record a location, time, and quantity of treatment for each among said plurality of unwanted plants 302 using said controller 206.

In one embodiment, said herbicide pellet system 104 can be suited for ranch work which can often be conducted from the back of a horse. Wherein, a workman can ride said horse, and distribute a plurality of said herbicide pellet 106 around said ranchland 300 without dismounting said horse. This advantage increase efficiency of treating said plurality of unwanted plants 302 with said herbicide pellet system 104.

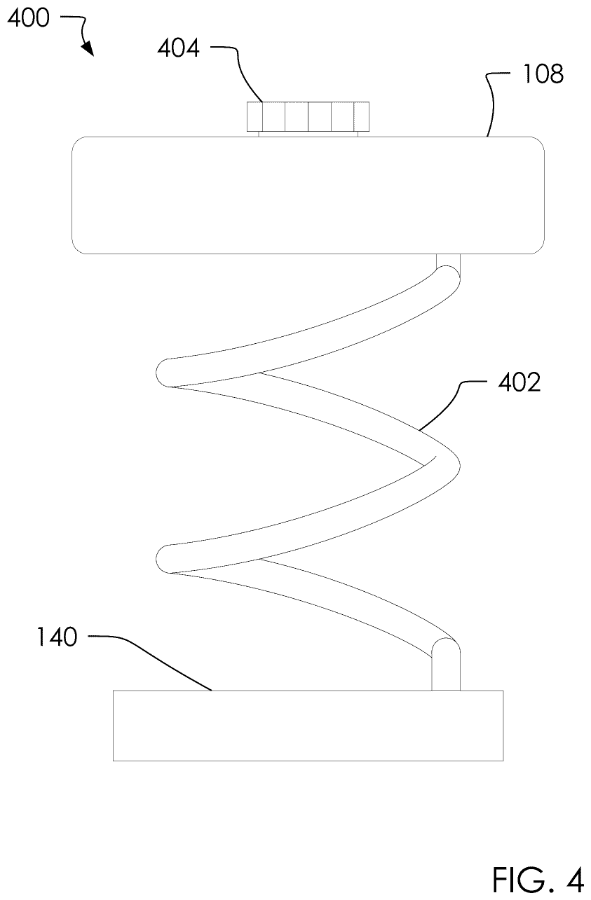

FIG. 4 illustrates a drone bullet feeding assembly 400.

In one embodiment, said drone bullet feeding assembly 400 can comprise said hopper 108 in connection with said bullet dropping system 202, as illustrated in said drone delivery system 200, above. However, as illustrated, said drone bullet feeding assembly 400 can comprise said hopper 108 being connected to said bullet dropping system 202 by a helical tube 402.

In one embodiment, said helical tube 402 can be adapted to ensure said herbicide pellet 106 do not clog up a passage between said hopper 108 and said plurality of unwanted plants 302 by causing said herbicide pellet 106 to roll along said waistband 164, as discussed above and illustrated in FIG. 1F.

In one embodiment, said drone delivery system 200 can comprise a cap 404 on said hopper 108 being configured for selectively enclosing said hopper 108.

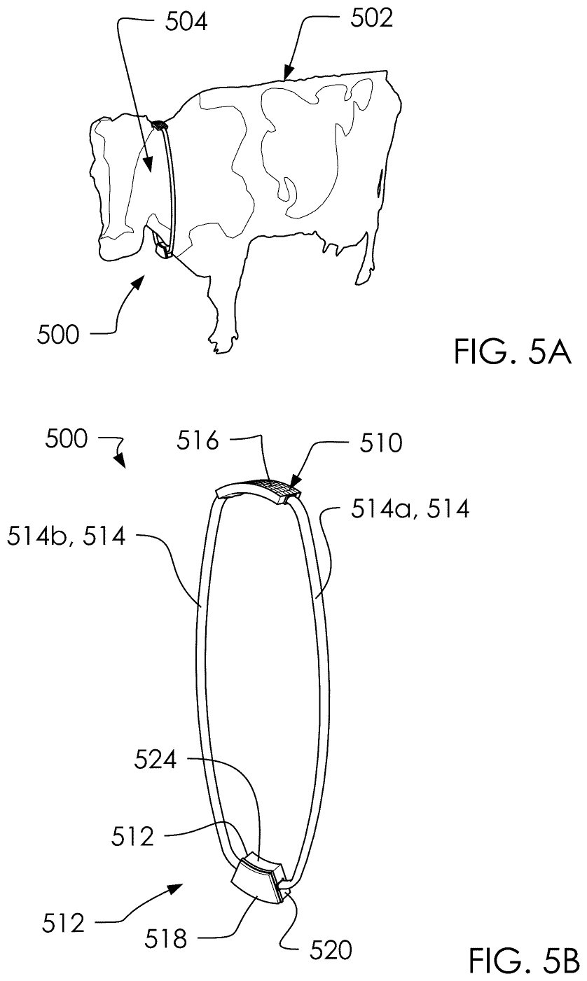

FIG. 5A illustrates a perspective overview of a livestock herbicide delivery system 500 on a livestock 502.

Said herbicide pellet system 104 can further comprise said livestock herbicide delivery system 500 configured to rest around a portion of said sights 502 and deliver said herbicide pellet 106 to said plurality of unwanted plants 302 as said livestock 502 roams around said ranchland 300.

Said livestock herbicide delivery system 500 can fit around a neck 504 of said livestock 502, as illustrated. Said livestock herbicide delivery system 500 can therefore be carried along with said livestock 502 as it grazes and moves about.

FIG. 5B illustrates a perspective overview of said livestock herbicide delivery system 500.

In one embodiment, said livestock herbicide delivery system 500 can comprise an upper portion 510, a lower portion 512 and two side portions 514. Said two side portions 514 can comprise a first side portion 514a and a second side portion 514b. Said two side portions 514 can connect between said upper portion 510 and said lower portion 512 on either side of said neck 504 of said livestock 502.

In one embodiment, said upper portion 510 can comprise a solar panel 516 for charging portions of said livestock herbicide delivery system 500.

In one embodiment, said two side portions 514 can be hollow and configured to hold one or more of said herbicide pellet 106. Wherein, with said livestock herbicide delivery system 500 loaded with a plurality of said herbicide pellet 106, said herbicide pellet 106 can roll down from said upper portion 510 toward said lower portion 512.

In one embodiment, said lower portion 512 can be configured to selectively release a portion of said herbicide pellet 106, as discussed herein.

Said lower portion 512 can comprise a lid portion 518, a first side 520, a second side 522 and a body 524.

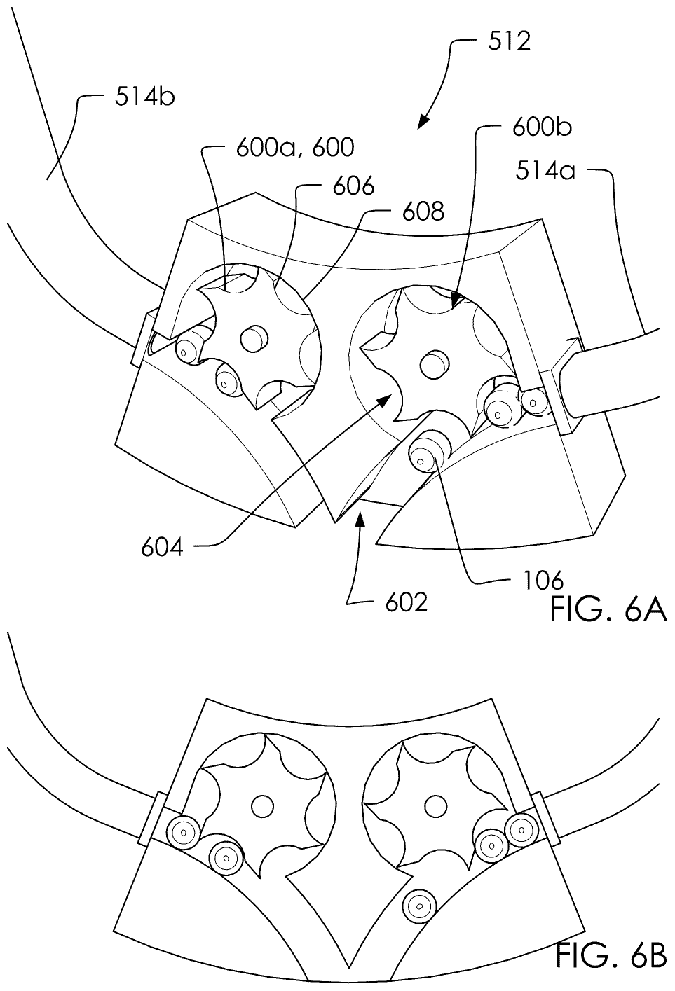

FIGS. 6A and 6B illustrate a perspective overview and elevated side view of said lower portion 512 without a said lid portion 518 attached.

In one embodiment, said lower portion 512 can comprise one or more release assemblies 600, such as a first release assembly 600a and a second release assembly 600b. Said one or more release assemblies 600 can be enclosed within said lower portion 512 between said two side portions 514 and a release aperture 602. Said one or more release assemblies 600 can be configured to selectively release one or more said herbicide pellet 106. Each said one or more release assemblies 600 can comprise a release wheel configured to selectively obstruct and release said herbicide pellet 106, as is known in the art.

In one embodiment, said two side portions 514 can be attached to said first side 520 and said second side 522 of said lower portion 512, as illustrated. Said two side portions 514 can allow said herbicide pellet 106 to roll into a portion of said lower portion 512.

In one embodiment, said one or more release assemblies 600 can each comprise a sprockets wheel 606 in a sprocket cavity 608. Each said sprockets wheel 606 can comprise a plurality of sprocket gaps 604 for controlling the movement of said herbicide pellet 106. By selectively rotating said sprockets wheel 606, said livestock herbicide delivery system 500 can be configure to selectively isolate and release said herbicide pellet 106.

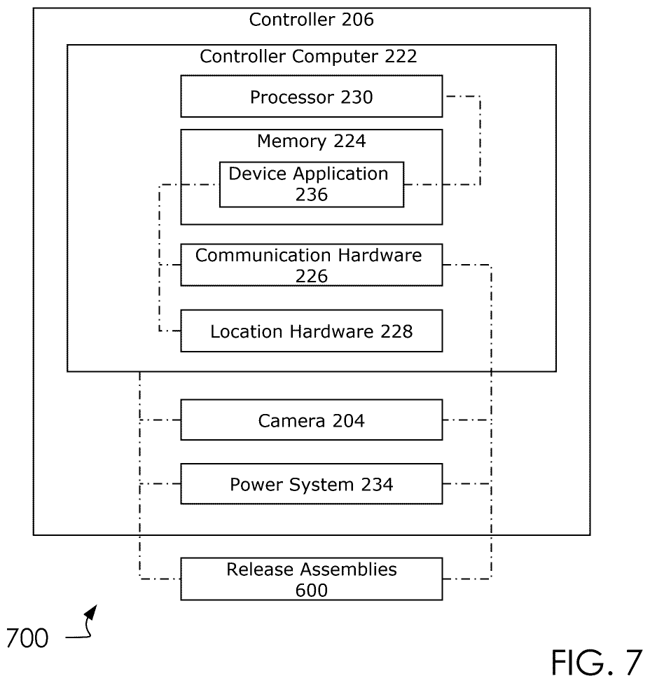

FIG. 7 illustrates a block diagram 700 of said livestock herbicide delivery system 500.

In one embodiment, said livestock herbicide delivery system 500 can comprise said controller 206.

In one embodiment, can comprise said controller 206 can comprise said controller computer 222 having at least said memory 224, said communication hardware 226, said location hardware 228, said processor 230, said power system 234 and said device application 236. As is known in the art, each of the parts of said controller 206 can be understood to be a plurality of that part, such as a multi-processor chip, plurality of storage medium or other hardware.

Further, said livestock herbicide delivery system 500 can comprise said one or more release assemblies 600.

Said livestock herbicide delivery system 500 can further comprise said device application 236 which can be stored in said memory 224 and to executed in said processor 230.

In one embodiment, said device application 236 can be configured to receive visual data from said camera 204, and location and positioning data from said location hardware 228.

As is known in the art, said location hardware 228 can comprise GPS or similar; said power system 234 can comprise a battery or battery pack; said communication hardware 226 can comprise a wired bus, a wireless protocol, or a wireless networking standard; said controller 206 can comprise a system-on-a-chip or a plurality of components. In one embodiment, said location hardware 228 can be separate from and commanded by said controller 206.

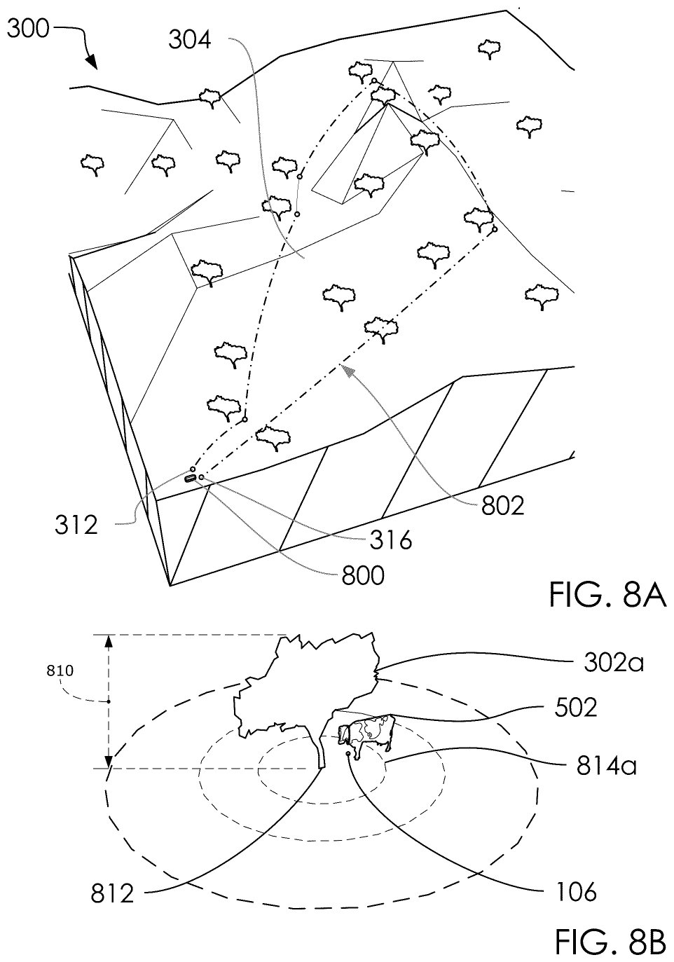

FIG. 8A illustrates a detailed view of said ranchland 300 with a plurality of said livestock 502 under a portion of said plurality of unwanted plants 302 with a migration path 802 of a portion of said livestock 502.

In one embodiment, said livestock 502 can traverse said ranchland 300 as between a portion of said plurality of unwanted plants 302 and a watering location 800, as is known in the art.

One features of said livestock herbicide delivery system 500 can comprise an awareness of said plurality of unwanted plants 302, its location and a capacity to selectively release said herbicide pellet 106 according to a treatment plan, as discussed below.

Referring now to the incorporated patents ('440 and '816) which contemplate delivery systems of said herbicide pellet 106, it is noted that said livestock 502 is not as easily controlled as say a drone or workman. Instead, said livestock herbicide delivery system 500 seeks to use the natural and uninduced movement of said livestock 502 for the distribution of said herbicide pellet 106 in said ranchland 300.

For example, in one embodiment, said livestock 502 can move along said migration path 802 from said starting point 312 to said one or more target points 314 within said ranchland 300 and eventually to said end point 316. Examples of said starting point 312 and said end point 316 can comprise said watering location 800, feed area, shade or similar, as is known in the art.

Wherein, said one or more target points 314 can comprise a portion of said plurality of unwanted plants 302. It is unlikely that said livestock 502 will travel to all said plurality of unwanted plants 302, but given enough said livestock 502 and time, it is possible.

In one embodiment, said device application 236 can be preprogrammed with a location and size of each said plurality of unwanted plants 302 within said ranchland 300.

FIG. 8B illustrates a perspective overview of said livestock 502 under said unwanted plant 302a.

One feature of said livestock herbicide delivery system 500 can be configured to release said herbicide pellet 106 when said livestock 502 is below a known location of said unwanted plant 302a.

As discussed above a plant height 810 and a plant location 812 can be preprogrammed into said device application 236; wherein, said device application 236 can calculate a dosage of said herbicide pellet 106 to be released when said livestock 502 enters a target zone 814a in proximity to said unwanted plant 302a.

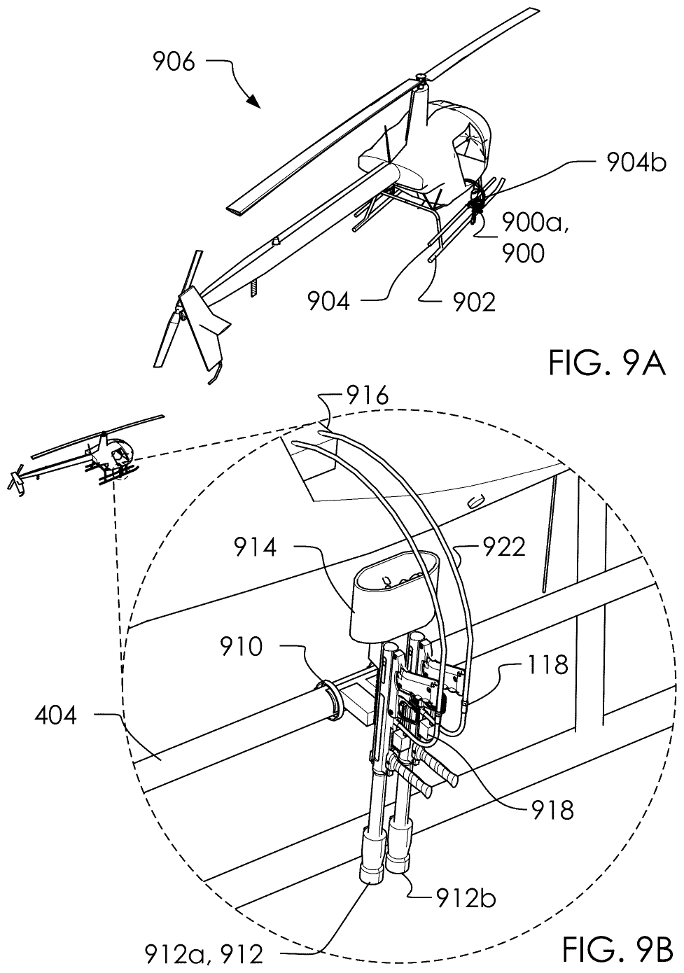

FIGS. 9A and 9B illustrate a perspective overview and detailed view of a helicopter 906 with one or more herbicide dispenser assemblies 900.

As is known in the art, said helicopter 906 can comprise two landing skids 902 skids below the cockpit and adapted for landing. In one embodiment, said one or more herbicide dispenser assemblies 900 can attach to a portion of said two landing skids 902. In another embodiment, said one or more herbicide dispenser assemblies 900 can be attached to a portion of a fuselage or other fixed portion of said helicopter 906. As illustrated herein, said two landing skids 902 can comprise an upper skid 904.

In one embodiment, said one or more herbicide dispenser assemblies 900 can comprise a mounting assembly 910, one or more herbicide dispensers 912, a pellet hopper 914, a compressor 916 and a triggering assembly 918. In one embodiment, said pellet hopper 914 can be configured for delivering said herbicide pellet 106 to said one or more herbicide dispensers 912.

For each among said one or more herbicide dispensers 912, said compressor 916 can be in a fluid connection with said pressurized gas inlet 118 with an air hose 922.

In one embodiment, said one or more herbicide dispensers 912 can comprise air guns such as said herbicide pellet gun 100. In another embodiment, said one or more herbicide dispensers 912 can comprise purpose built dispensing equipment such that it does not resemble a firearm.

In one embodiment, said triggering assembly 918 can selectively activate a trigger where said one or more herbicide dispensers 912 comprise firearms.

In one embodiment, said one or more herbicide dispensers 912 can comprise a first herbicide dispenser 912a and a second herbicide dispenser 912b.

Said mounting assembly 910 can be configured to wrap around a portion of said upper skid 904.

Said pellet hopper 914 can comprise a container for holding a plurality of said herbicide pellet 106 and allow said herbicide pellet 106 to roll into an ammunition receiver port of said one or more herbicide dispensers 912.

In one embodiment, said herbicide pellet system 104 can be utilized to rapidly treat said plurality of unwanted plants 302 on said ranchland 300 with one or more of said workman in said mounting assembly 910.

Accordingly, a method of use of said herbicide pellet system 104 can comprise: arming one or more of said workman with said herbicide pellet gun 100, loading said herbicide pellet gun 100 with a plurality of said herbicide pellet 106, loading said workman into said mounting assembly 910, flying over said ranchland 300 in a ground coverage pattern, shooting a portion of said plurality of unwanted plants 302 with said herbicide pellet 106, continuing to cover said ranchland 300 with said mounting assembly 910 until said ranchland 300 is sufficiently treated with said herbicide pellet 106.

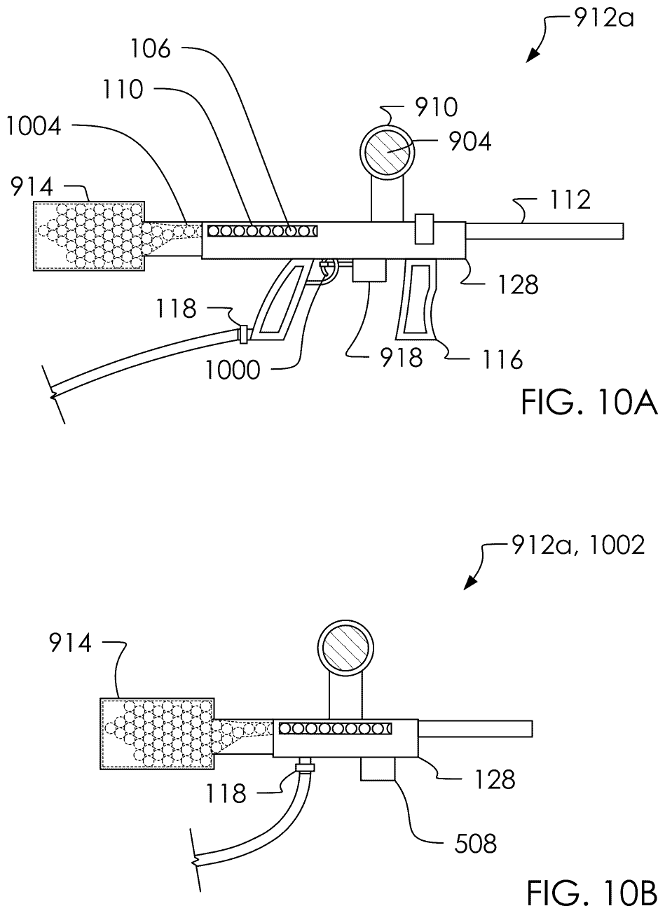

FIG. 10A illustrates a 2D elevated side view of said first herbicide dispenser 912a.

It is noted that FIGS. 10A and 10B are rotated 90 degrees from their illustrations in FIGS. 9A-B.

As illustrated, said one or more herbicide dispensers 912 are simplified for discussion purposes. In one embodiment, said pellet hopper 914 can be arranged over an ammunition inlet 1004 and receive a plurality of said herbicide pellet 106. In one embodiment, said herbicide pellet 106 can feed into said ammunition inlet 1004 by gravity, springs, air pressure, or mechanical means. In one embodiment, said herbicide pellet 106 can be funneled into said ammunition inlet 1004.

In one embodiment, said barrel 112 can be arranged above said two landing skids 902 to prevent damage to said one or more herbicide dispensers 912 during take-off and landing.

Said triggering assembly 918 can selectively press and release a trigger 1000 of said one or more herbicide dispensers 912.

FIG. 10B illustrates a simplified configuration 1002 of said first herbicide dispenser 912a.

In one embodiment, said one or more herbicide dispensers 912 can be based on said herbicide pellet gun 100, as previously discussed and illustrated. In another embodiment, said one or more herbicide dispensers 912 can comprise a system designed without said trigger 1000, said first grip 114, said second grip 116, or any other tools for use as a firearm. In this configuration, referred to as said simplified configuration 1002, said one or more herbicide dispensers 912 can comprise said pressurized gas inlet 118, said triggering assembly 918, said ammunition feeder tube 110 and said ammunition inlet 1004; wherein, said pellet hopper 914 can feed in said herbicide pellet 106 for use by said one or more herbicide dispenser assemblies 900.

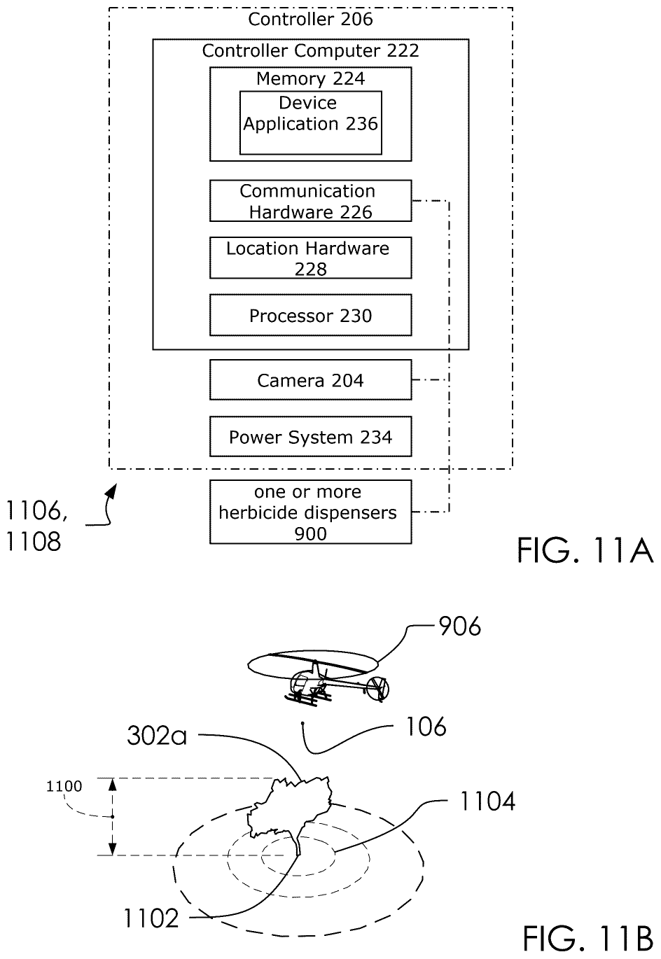

FIG. 11A illustrates a block diagram 1106 of a flight herbicide dispenser assembly 1108 comprising said one or more herbicide dispenser assemblies 900.

In one embodiment, said flight herbicide dispenser assembly 1108 can comprise said controller 206 comprising at least said memory 224, said communication hardware 226, said location hardware 228, said processor 230, said power system 234 and said device application 236

Said flight herbicide dispenser assembly 1108 can comprise said camera 204 and said power system 234.

Said flight herbicide dispenser assembly 1108 can further comprise said device application 236 stored in said memory 224 and to execute in said processor 230. In one embodiment, said device application 236 can be configured to receive visual data from said camera 204, and location and positioning data from said location hardware 228.

In one embodiment, said device application 236 can be programmed for: capturing images of said plurality of unwanted plants 302 as said one or more herbicide dispenser assemblies 900 flies over said ranchland 300, collecting locations of said images according to a known location such as GPS, and processing and mapping the location of said plurality of unwanted plants 302. In one embodiment, said device application 236 can further be configured for: automatically identifying said plurality of unwanted plants 302, hovering over a portion of said plurality of unwanted plants 302, dropping said herbicide pellet 106 on a portion of said plurality of unwanted plants 302 using said one or more herbicide dispensers 912 and making a record of each among said plurality of unwanted plants 302 which have been treated with said herbicide pellet 106.

As is known in the art: said location hardware 228 can comprise GPS, gyroscopes, or similar; said power system 234 can comprise a battery or battery pack; said communication hardware 226 can comprise a wired bus, a wireless protocol, or a wireless networking standard; said controller 206 can comprise a system-on-a-chip or a plurality of components. In one embodiment, navigation hardware can be separate from and commanded by said device application 236.

In one embodiment, said device application 236 can direct a pilot of said helicopter 906 to follow said flight plan 310, as discussed with said drone delivery system 200, above.

In one embodiment, said flight herbicide dispenser assembly 1108 can be configured for loading said flight plan 310 into said power system 234. In one embodiment, said flight plan 310 can comprise a collection of 3D points across and above said ranchland 300 being configured to be clear of obstacles and above a portion of said plurality of unwanted plants 302.

In one embodiment, an aviator of said helicopter 906 can review and follow a portion of said flight plan 310 so as to locate and hover over a portion of said plurality of unwanted plants 302; wherein, said one or more herbicide dispensers 912 can be configured to automatically dispense said herbicide pellet 106 onto said plurality of unwanted plants 302 according to a dosing plan (such as 2 pellets for a 6 foot tree as discussed above). In one embodiment, said device application 236 can display said flight plan 310 on a screen within said helicopter 906. In one embodiment, said triggering assembly 918 can be activated by a human or by said device application 236.

FIG. 11B illustrates a perspective overview of said one or more herbicide dispenser assemblies 900 over said unwanted plant 302a.

In one embodiment, said device application 236 can be loaded with a plant height 1100 and a plant location 1102 for a portion of said plurality of unwanted plants 302. Wherein said device application 236 can calculate a dosage of said herbicide pellet 106 to be released over a target zone 1104 in proximity to said unwanted plant 302a. In one embodiment, said device application 236 can be loaded with tolerances of said target zone 1104 such an effective radius of said herbicide pellet 106 for a given tree or plant type.

The following may be considered a preferred embodiment of the current specification.

Said herbicide pellet system 104 for efficient and accurate delivery of herbicides to said plurality of unwanted plants 302 can comprise said herbicide pellet system 104 comprising said herbicide pellet 106 and a delivery system for distributing said herbicide pellet 106 to a portion of said plurality of unwanted plants 302. Said herbicide pellet 106 comprises a non-liquid degradable herbicide configured to release an herbicide near said unwanted plant 302a after a period or a rain event. Said delivery system can be configured to project said herbicide pellet 106 as a projectile toward said unwanted plant 302a among said plurality of unwanted plants 302. Said herbicide pellet 106 can be of sufficient weight and shape to travel through the air in a predictable trajectory when projected by said delivery system. Said herbicide pellet 106 can be configured to carry an herbicide dosage of an herbicide. Said herbicide dosage can be calculated to correlate with said plant height 810 of said unwanted plant 302a. Accordingly, said herbicide pellet system 104 can be configured for: allowing a workman to visually judge said plant height 810 of said unwanted plant 302a, calculating an appropriate dosage of herbicide according to said plant height 810 of said unwanted plant 302a by dividing an apparent height of said plant height 810 by a dosage per height, and applying a multiple of said herbicide pellet 106 to said unwanted plant 302a. Said delivery system of said herbicide pellet system 104 comprises said herbicide pellet gun 100. Said herbicide pellet gun 100 can be configured for shooting said herbicide pellet 106 at a portion of said plurality of unwanted plants 302. Said herbicide pellet gun 100 comprises said hopper 108, said barrel 112 and said body 128. Said hopper 108 can be configured to hold a plurality of said herbicide pellet 106. Said herbicide pellet system 104 comprises a method of use can comprise loading at least one of said herbicide pellet 106 in said hopper 108 of said herbicide pellet gun 100, transferring said herbicide pellet 106 into said ammunition inlet 126 of said herbicide pellet gun 100, aiming said barrel 112 at said unwanted plant 302a, shooting said herbicide pellet 106 at said unwanted plant 302a, and allowing said herbicide pellet 106 to release an herbicide configured to kill said unwanted plant 302a. Said herbicide pellet 106 comprise a weight between 0. 8 and 2 grams. Said herbicide pellet 106 can be configured to travel through the air when fired by said herbicide pellet gun 100 in a predictable trajectory.

Said herbicide pellet system 104 for efficient and accurate delivery of herbicides to said plurality of unwanted plants 302 can comprise said herbicide pellet system 104 comprising said herbicide pellet 106 and a delivery system for distributing said herbicide pellet 106 to a portion of said plurality of unwanted plants 302. Said herbicide pellet 106 comprises a non-liquid degradable herbicide configured to release an herbicide near said unwanted plant 302a after a period or a rain event. Said delivery system can be configured to project said herbicide pellet 106 as a projectile toward said unwanted plant 302a among said plurality of unwanted plants 302. Said herbicide pellet 106 can be of sufficient weight and shape to travel through the air in a predictable trajectory when projected by said delivery system. Said herbicide pellet 106 can be configured to carry an herbicide dosage of an herbicide. Said herbicide dosage can be calculated to correlate with said plant height 810 of said unwanted plant 302a. Accordingly, said herbicide pellet system 104 can be configured for: allowing a workman to visually judge said plant height 810 of said unwanted plant 302a, calculating an appropriate dosage of herbicide according to said plant height 810 of said unwanted plant 302a by dividing an apparent height of said plant height 810 by a dosage per height, and applying a multiple of said herbicide pellet 106 to said unwanted plant 302a. Said delivery system of said herbicide pellet system 104 comprises said herbicide pellet gun 100. Said herbicide pellet gun 100 can be configured for shooting said herbicide pellet 106 at a portion of said plurality of unwanted plants 302. Said herbicide pellet gun 100 comprises said hopper 108, said barrel 112 and said body 128. Said hopper 108 can be configured to hold a plurality of said herbicide pellet 106. Said herbicide pellet system 104 comprises a method of use can comprise loading at least one of said herbicide pellet 106 in said hopper 108 of said herbicide pellet gun 100, transferring said herbicide pellet 106 into said ammunition inlet 126 of said herbicide pellet gun 100, aiming said barrel 112 at said unwanted plant 302a, shooting said herbicide pellet 106 at said unwanted plant 302a, and allowing said herbicide pellet 106 to release an herbicide configured to kill said unwanted plant 302a. Said herbicide pellet 106 comprise a weight between 0. 8 and 2 grams. Said herbicide pellet 106 can be configured to travel through the air when fired by said herbicide pellet gun 100 in a predictable trajectory.

Said herbicide pellet system 104 for efficient and accurate delivery of herbicides to said plurality of unwanted plants 302 can comprise said herbicide pellet system 104 comprising said herbicide pellet 106 and a delivery system for distributing said herbicide pellet 106 to a portion of said plurality of unwanted plants 302. Said herbicide pellet 106 comprises a non-liquid degradable herbicide configured to release an herbicide near said unwanted plant 302a after a period or a rain event. Said delivery system can be configured to project said herbicide pellet 106 as a projectile toward said unwanted plant 302a among said plurality of unwanted plants 302. Said herbicide pellet 106 can be of sufficient weight and shape to travel through the air in a predictable trajectory when projected by said delivery system.

Said herbicide pellet 106 comprises an herbicide known in the United States as a “2,4-D Herbicide” being formulated for the treatment of and destruction of said plurality of unwanted plants 302.

Said herbicide pellet 106 can be configured to carry an herbicide dosage of an herbicide. Said herbicide dosage can be calculated to correlate with said plant height 810 of said unwanted plant 302a. Accordingly, said herbicide pellet system 104 can be configured for: allowing a workman to visually judge said plant height 810 of said unwanted plant 302a, calculating an appropriate dosage of herbicide according to said plant height 810 of said unwanted plant 302a by dividing an apparent height of said plant height 810 by a dosage per height, and applying a multiple of said herbicide pellet 106 to said unwanted plant 302a.

Said delivery system of said herbicide pellet system 104 comprises said herbicide pellet gun 100. Said herbicide pellet gun 100 can be configured for shooting said herbicide pellet 106 at a portion of said plurality of unwanted plants 302. Said herbicide pellet gun 100 comprises said hopper 108, said barrel 112 and said body 128. Said hopper 108 can be configured to hold a plurality of said herbicide pellet 106. Said herbicide pellet system 104 comprises a method of use can comprise loading at least one of said herbicide pellet 106 in said hopper 108 of said herbicide pellet gun 100, transferring said herbicide pellet 106 into said ammunition inlet 126 of said herbicide pellet gun 100, aiming said barrel 112 at said unwanted plant 302a, shooting said herbicide pellet 106 at said unwanted plant 302a, and allowing said herbicide pellet 106 to release an herbicide configured to kill said unwanted plant 302a.

Said herbicide pellet gun 100 further comprises said ammunition feeder tube 110, and said ammunition inlet 126. Said ammunition feeder tube 110 can be configured to transfer said herbicide pellet 106 from said hopper 108 into said ammunition inlet 126 of said herbicide pellet gun 100. Each among said herbicide pellet 106 comprises said two rounded ends 162 and said waistband 164. Said waistband 164 can be cylindrical and configured to allow said herbicide pellet 106 to roll along said waistband 164. Said herbicide pellet 106 comprises said bullet height 148 and said bullet width 150. Said ammunition feeder tube 110 comprises said feeder tube height 144 and said feeder tube width 146 being configured to be substantially equal to said bullet height 148 and said bullet width 150, respectively. Said ammunition feeder tube 110 comprises a hollow cylinder to allow said herbicide pellet 106 to roll freely within said ammunition feeder tube 110. Said bullet height 148 can be longer than said bullet width 150. Wherein, as a plurality of said herbicide pellet 106 roll down the length of said ammunition feeder tube 110, they will naturally align within said ammunition feeder tube 110 and roll along said waistband 164 so as to avoid entanglement with adjacent bullets.

Said herbicide pellet 106 comprises a 50-caliber size.

Said herbicide pellet 106 comprise a weight between 0.8 and 2 grams. Said herbicide pellet 106 can be configured to travel through the air when fired by said herbicide pellet gun 100 in a predictable trajectory.

Said herbicide pellet 106 comprise a weight substantially equal to 1.25 grams. Said herbicide pellet 106 can be configured to travel through the air when fired by said herbicide pellet gun 100 in a predictable trajectory.

Said ammunition feeder tube 110 connects between said feed neck 120 and said ammunition inlet 126 in said body 128 of said herbicide pellet gun 100. Said ammunition feeder tube 110 connects to said feed neck 120 at a point being relatively above said ammunition inlet 126 when oriented with said first grip 114 toward the ground. Said herbicide pellet 106 travels within said ammunition feeder tube 110 as pulled by gravity from said feed neck 120 to said ammunition inlet 126.

Said herbicide pellet gun 100 further comprises said pressurized gas inlet 118. Said pressurized gas inlet 118 can be configured to receive a compressed air in said pressurized gas inlet 118. Said herbicide pellet gun 100 can be configured to project said herbicide pellet 106 using compressed air provide from said compressed gas can 122.

Said herbicide pellet gun 100 comprises an electric accelerator for shooting said herbicide pellet 106.

Said ammunition delivery assembly 130 can be offset from said barrel 112 to allow for aiming and sights down the length of said barrel 112.

Said delivery system of said herbicide pellet system 104 comprises said drone delivery system 200. Said drone delivery system 200 can be configured for transporting one or more among said herbicide pellet 106 around said ranchland 300, and projecting said herbicide pellet 106 at a portion of said plurality of unwanted plants 302. Said drone delivery system 200 comprises said hopper 108, said bullet dropping system 202, said controller 206, said plurality of propellers 208, said support frame 210, said power system 234, and said plurality of prop motors 232 connected to said plurality of propellers 208. Said controller 206 comprises said controller computer 222 comprising at least said memory 224, said communication hardware 226, said location hardware 228 and said processor 230. Said herbicide pellet system 104 comprises said device application 236 configured to be stored in said memory 224 and to execute in said processor 230. Said device application 236 can be configured to receive a location and positioning data from said location hardware 228. Said device application 236 can be configured to process said location and positioning data and to control a location of said drone delivery system 200 using said plurality of prop motors 232.

Said drone delivery system 200 further comprise said camera 204. Said device application 236 can be programmed for: flying over said ranchland 300, capturing images of said plurality of unwanted plants 302 with said camera 204 according to a known location such as GPS, and processing and mapping the location of said plurality of unwanted plants 302. Said device application 236 can be configured for: automatically identifying said plurality of unwanted plants 302, hovering over a portion of said plurality of unwanted plants 302, dropping said herbicide pellet 106 on a portion of said plurality of unwanted plants 302 using said bullet dropping system 202, and making a record of each among said plurality of unwanted plants 302 which have been treated with said herbicide pellet 106.

Said herbicide pellet system 104 further comprises said flight plan 310 being loaded into said device application 236. Said flight plan 310 comprises a collection of 3D points across and above said ranchland 300 being configured to be clear of obstacles and above a portion of said plurality of unwanted plants 302. In conjunction with said device application 236, said flight plan 310 can be used for flying said drone delivery system 200 from said starting point 312, to said one or more target points 314 above a portion of said plurality of unwanted plants 302, releasing said herbicide pellet 106 over said unwanted plant 302a, documenting treatment, and flying said drone delivery system 200 to said end point 316.

Said herbicide pellet system 104 further comprises said livestock herbicide delivery system 500 configured to rest around a portion of said sights 502 and deliver said herbicide pellet 106 to said plurality of unwanted plants 302 as said livestock 502 roams around said ranchland 300. Said livestock herbicide delivery system 500 fits around said neck 504 of said livestock 502. Said livestock herbicide delivery system 500 can be configured to use the natural and uninduced movement of said livestock 502 for the distribution of said herbicide pellet 106 in said ranchland 300.

Said delivery system of said herbicide pellet system 104 comprises said one or more herbicide dispenser assemblies 900 configured to attach to a portion of said helicopter 906. Said one or more herbicide dispenser assemblies 900 comprise said one or more herbicide dispensers 912, said pellet hopper 914 and said triggering assembly 918. Said pellet hopper 914 can be configured for delivering said herbicide pellet 106 to said one or more herbicide dispensers 912. Said flight herbicide dispenser assembly 1108 comprises said controller 206 comprising at least said camera 204, said memory 224, said communication hardware 226, said location hardware 228, said processor 230, said power system 234 and said device application 236. Said flight herbicide dispenser assembly 1108 further comprises said device application 236 stored in said memory 224 and to execute in said processor 230.

Said device application 236 directs a pilot of said helicopter 906 to follow said flight plan 310, as discussed with said drone delivery system 200, above. Said flight herbicide dispenser assembly 1108 can be configured for loading said flight plan 310 into said power system 234. Said flight plan 310 comprises a collection of 3D points across and above said ranchland 300 being configured to be clear of obstacles and above a portion of said plurality of unwanted plants 302. Said device application 236 display said flight plan 310 on a screen within said helicopter 906. Said triggering assembly 918 can be activated by a human or by said device application 236.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An herbicide pellet system for efficient and accurate delivery of herbicides to plurality of unwanted plants, comprising:
said herbicide pellet system comprising an herbicide pellet and a delivery system for distributing said herbicide pellet to a portion of said plurality of unwanted plants;
said herbicide pellet comprises a non-liquid, water-soluble, degradable herbicide formulation, configured to release an herbicide near unwanted plant after a period or a rain event, ensuring effective deployment in arid conditions;
said delivery system is configured to project said herbicide pellet as a projectile toward said unwanted plant among said plurality of unwanted plants;
said herbicide pellet is of sufficient weight and shape to travel through the air in a predictable trajectory when projected by said delivery system, being semi-rigid and devoid of an outer shell, thus maintaining integrity during acceleration and projection;
said herbicide pellet is configured to carry an herbicide dosage of an herbicide;
said herbicide dosage is calculated to correlate with a plant height of said unwanted plant;
accordingly, said herbicide pellet system is configured for:
allowing a workman to visually judge said plant height of said unwanted plant,
calculating an appropriate dosage of herbicide according to said plant height of said unwanted plant by dividing an apparent height of said plant height by a dosage per height, and
applying a multiple of said herbicide pellet to said unwanted plant;
said delivery system of said herbicide pellet system comprises herbicide pellet gun;
said herbicide pellet gun is configured for shooting said herbicide pellet at a portion of said plurality of unwanted plants;
said herbicide pellet gun comprises hopper, barrel and a body;
said hopper is configured to hold a plurality of said herbicide pellet;
said herbicide pellet system comprises a method of use comprising:
loading at least one of said herbicide pellet in said hopper of said herbicide pellet gun,
transferring said herbicide pellet into ammunition inlet of said herbicide pellet gun,
aiming said barrel at said unwanted plant,
shooting said herbicide pellet at said unwanted plant, and
allowing said herbicide pellet to release an herbicide configured to kill said unwanted plant;
said herbicide pellet comprise a weight between 0.8 and 2 grams; and
said herbicide pellet are configured to travel through the air when fired by said herbicide pellet gun in a predictable trajectory.

2. An herbicide pellet system for efficient and accurate delivery of herbicides to plurality of unwanted plants, comprising:
said herbicide pellet system comprising an herbicide pellet and a delivery system for distributing said herbicide pellet to a portion of said plurality of unwanted plants;
said herbicide pellet comprises a non-liquid, water-soluble, degradable herbicide formulation, configured to release an herbicide near unwanted plant after a period or a rain event, ensuring effective deployment in arid conditions;
said delivery system is configured to project said herbicide pellet as a projectile toward said unwanted plant among said plurality of unwanted plants;
said herbicide pellet is of sufficient weight and shape to travel through the air in a predictable trajectory when projected by said delivery system, being semi-rigid and devoid of an outer shell, thus maintaining integrity during acceleration and projection;
the herbicide pellet, being water-soluble, is configured for gradual dissolution at the target site;
the herbicide pellet is configured to carry an herbicide dosage of an herbicide;
the herbicide dosage is calculated to correlate with a plant height of the unwanted plant;
accordingly, the herbicide pellet system is configured for:
allowing a workman to visually judge the plant height of the unwanted plant,
calculating an appropriate dosage of herbicide according to the plant height of the unwanted plant by dividing an apparent height of the plant height by a dosage per height, and
applying a multiple of the herbicide pellet to the unwanted plant.

3. The herbicide pellet system of claim 2, wherein:
said herbicide pellet comprises an herbicide known in the United States as 2,4-D Herbicide being formulated for the treatment of and destruction of said plurality of unwanted plants.

4. The herbicide pellet system of claim 2, wherein:
said delivery system of said herbicide pellet system comprises herbicide pellet gun;
said herbicide pellet gun is configured for shooting said herbicide pellet at a portion of said plurality of unwanted plants;
said herbicide pellet gun comprises hopper, barrel and a body;
said hopper is configured to hold a plurality of said herbicide pellet; and
said herbicide pellet system comprises a method of use comprising:
loading at least one of said herbicide pellet in said hopper of said herbicide pellet gun,
transferring said herbicide pellet into ammunition inlet of said herbicide pellet gun,
aiming said barrel at said unwanted plant,
shooting said herbicide pellet at said unwanted plant, and
allowing said herbicide pellet to release an herbicide configured to kill said unwanted plant.

5. The herbicide pellet system of claim 4, wherein:
said herbicide pellet gun further comprises an ammunition feeder tube, and said ammunition inlet;
said ammunition feeder tube is configured to transfer said herbicide pellet from said hopper into said ammunition inlet of said herbicide pellet gun;
each among said herbicide pellet comprises two rounded ends and a waistband;
said waistband is cylindrical and configured to allow said herbicide pellet to roll along said waistband;
said herbicide pellet comprises a bullet height and a bullet width;
said ammunition feeder tube comprises a hollow cylinder to allow said herbicide pellet to roll freely within said ammunition feeder tube;
said bullet height is longer than said bullet width; and
wherein, as a plurality of said herbicide pellet roll down the length of said ammunition feeder tube, they will naturally align within said ammunition feeder tube and roll along said waistband so as to avoid entanglement with adjacent bullets.

6. The herbicide pellet system of claim 4, wherein:
said herbicide pellet comprises a 50-caliber size.

7. The herbicide pellet system of claim 4, wherein:
said herbicide pellet comprise a weight between 0.8 and 2 grams; and
said herbicide pellet are configured to travel through the air when fired by said herbicide pellet gun in a predictable trajectory.

8. The herbicide pellet system of claim 4, wherein:
said herbicide pellet comprise a weight within 10 percent of 1.25 grams; and
said herbicide pellet are configured to travel through the air when fired by said herbicide pellet gun in a predictable trajectory.

9. The herbicide pellet system of claim 4, wherein:
said ammunition feeder tube connects between a feed neck and said ammunition inlet in said body of said herbicide pellet gun;
said ammunition feeder tube connects to said feed neck at a point being relatively above said ammunition inlet when oriented with a first grip toward the ground;
said herbicide pellet travels within said ammunition feeder tube as pulled by gravity from said feed neck to said ammunition inlet.

10. The herbicide pellet system of claim 4, wherein:
said herbicide pellet gun further comprises a pressurized gas inlet;
said pressurized gas inlet is configured to receive a compressed air in said pressurized gas inlet; and
said herbicide pellet gun is configured to project said herbicide pellet using compressed air provide from a compressed gas can.

11. The herbicide pellet system of claim 4, wherein:
said herbicide pellet gun comprises an electric accelerator for shooting said herbicide pellet.

12. The herbicide pellet system of claim 4, wherein:
ammunition delivery assembly is offset from said barrel to allow for aiming and sights down the length of said barrel.

13. The herbicide pellet system of claim 2, wherein:
said delivery system of said herbicide pellet system comprises a drone delivery system;
said drone delivery system is configured for transporting one or more among said herbicide pellet around ranchland, and projecting said herbicide pellet at a portion of said plurality of unwanted plants;
said drone delivery system comprises said hopper, a bullet dropping system, a controller, a plurality of propellers, a support frame, a power system, and a plurality of prop motors connected to said plurality of propellers;
said controller comprises a controller computer comprising at least a memory, a communication hardware, a location hardware and a processor;
said herbicide pellet system comprises a device application configured to be stored in said memory and to execute in said processor;
said device application is configured to receive a location and positioning data from said location hardware;
said device application is configured to process said location and positioning data and to control a location of said drone delivery system using said plurality of prop motors.

14. The herbicide pellet system of claim 13, wherein:
said drone delivery system further comprise a camera;
said device application is programmed for:
flying over said ranchland,
capturing images of said plurality of unwanted plants with said camera according to a known location such as GPS, and
processing and mapping the location of said plurality of unwanted plants;
said device application is configured for:
automatically identifying said plurality of unwanted plants,
hovering over a portion of said plurality of unwanted plants,
dropping said herbicide pellet on a portion of said plurality of unwanted plants using said bullet dropping system,
and making a record of each among said plurality of unwanted plants which have been treated with said herbicide pellet.

15. The herbicide pellet system of claim 13, wherein:
said herbicide pellet system further comprises a flight plan being loaded into said device application;
said flight plan comprises a collection of 3D points across and above said ranchland being configured to be clear of obstacles and above a portion of said plurality of unwanted plants;
in conjunction with said device application, said flight plan is used for
flying said drone delivery system from a starting point, to one or more target points above a portion of said plurality of unwanted plants,
releasing said herbicide pellet over said unwanted plant,
documenting treatment, and
flying said drone delivery system to end point.

16. The herbicide pellet system of claim 2, wherein:
said herbicide pellet system further comprises a livestock herbicide delivery system configured to rest around a portion of a sights and deliver said herbicide pellet to said plurality of unwanted plants as a livestock roams around said ranchland;
said livestock herbicide delivery system fits around a neck of said livestock; and
said livestock herbicide delivery system is configured to use the natural and uninduced movement of said livestock for the distribution of said herbicide pellet in said ranchland.

17. The herbicide pellet system of claim 2, wherein:
said delivery system of said herbicide pellet system comprises one or more herbicide dispenser assemblies configured to attach to a portion of a helicopter;
said one or more herbicide dispenser assemblies comprise one or more herbicide dispensers, a pellet hopper and a triggering assembly;
said pellet hopper is configured for delivering said herbicide pellet to said one or more herbicide dispensers;
a flight herbicide dispenser assembly comprises said controller comprising at least said camera, said memory, said communication hardware, said location hardware, said processor, said power system and said device application; and
said flight herbicide dispenser assembly further comprises said device application stored in said memory and to execute in said processor.

18. The herbicide pellet system of claim 17, wherein:
said device application directs a pilot of said helicopter to follow said flight plan, as discussed with said drone delivery system, above;
said flight herbicide dispenser assembly is configured for loading said flight plan into said power system;
said flight plan comprises a collection of 3D points across and above said ranchland being configured to be clear of obstacles and above a portion of said plurality of unwanted plants;
said device application display said flight plan on a screen within said helicopter; and
said triggering assembly is activated by a human or by said device application.
